(19) United States
(12) Patent Application Publication
(10) Pub. No.: US 2010/0077690 A1
(43) Pub. Date: Apr. 1, 2010

(54) PANEL ASSEMBLY AND METHOD FOR MOUNTING A PANEL ASSEMBLY

(75) Inventor: Yves Durand, Aussonne (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 12/438,174

(22) PCT Filed: Aug. 28, 2007
(86) PCT No.: PCT/FR07/51849

§ 371 Date: Oct. 21, 2009

(30) Foreign Application Priority Data
Sep. 8, 2006 (FR) 0653648

(51) Int. Cl. E04C 2/38; E04B 1/38; B23P 17/00; B21D 53/88; B64C 3/26; B64C 1/12

(52) U.S. Cl. 52/578; 52/745.21; 29/527.1; 29/897.2; 244/123.1; 244/131

(57) ABSTRACT

A panel assembly and therefor in which two panels are connected to one another, where one surface of each of the panels includes a joggle, so as to include an upper plateau and a lower plateau, the two panels being connected to each other at their lower plateaus. The sum of the joggle heights of the two panels is for example equal to the sum of the accepted gap tolerances in the joint zone between the two panels.

### CROSS-REFERENCE TO RELATED APPLICATIONS

This application is the National Stage of International Application No. PCT/FR2007/051849 International Filing Date 28 Aug. 2007, which designated the United States of America and which International Application was published under PCT Article 21 (2) as WO Publication No. WO2008/029049 A1 and which claims priority to French Application No. 06 53648, filed on 8 Sep. 2006, the disclosures of which are incorporated herein by reference in their entireties.

### BACKGROUND

1. Field

The disclosed embodiments relate to a panel assembly in which at least two panels are longitudinally connected to each other. Longitudinally connected is defined as being connected edge to edge. More specifically, the disclosed embodiments relate to the joint zone between two panels of the panel assembly. The disclosed embodiments also relate to a method for mounting a panel assembly, in which at least two panels are longitudinally connected to one another.

More generally, the aspects of the disclosed embodiments can be applied when it is necessary to connect at least two panels, such as sheets of metal or composite material. The aspects of the disclosed embodiments can particularly be applied in the aeronautical domain, in which the joint between two adjacent panels of an assembly can significantly impact on the aerodynamic drag. The aspects of the disclosed embodiments can also be applied in the automotive or railway domain, for the assembly of panels designed to form the external bodywork of a motor vehicle or a railway carriage.

2. Brief Description of Related Developments

In the aeronautical domain, the longitudinal connection of a succession of panels is known, in order to create a panel assembly, in particular to form the skin of the fuselage or of the wings of the aircraft.

For example, as is shown in FIG. 1, it is known to use a liaison 3 element to which each of the panels 1, 2 is connected, in order to make the joint between said adjacent panels 1, 2 removable. A first panel is removably fixed on the liaison 3 part via a removable screw 4. The second panel 2 is fixed on the liaison 3 part via one or several structural 5 screws. Therefore, when wishing to access the internal space created by the panels 1,2, it is simply necessary to remove the first panel 1 by unscrewing the removable 4 screw.

Panels 1, 2 are positioned adjacently, without being edge to edge, so as to create a longitudinal 6 slot between said adjacent panels 1,2. This longitudinal 6 slot is necessary, but can disrupt the airflow on the external surface of the panels 1,2.

Filling the longitudinal slot 6 with a sealing joint 7 in order to reduce the impact of the longitudinal 6 slot at the joint between the two panels 1, 2, is known. The sealing joint 7 permits the smoothing of the surface between the two adjacent panels 1, 2.

The liaison 3 part comprises a joggle 8, or stepped overlap, designed to compensate for the difference in thickness between the first panel 1 and the second panel 2. The thickness of a panel is generally defined as being the dimension of the said panel extending perpendicularly to the external surface of the said panel. Indeed, the thickness e of the first panel 1, at the joint zone between two panels, is strictly less than the thickness E of the second panel 2. The joint zone is defined as the portion of the surface of each of the panels 1, 2, involved in the liaison between these said panels. Thus the height of the joggle 8 corresponds to the difference between the thickness E of the second panel 2 and the thickness e of the first panel 1. The aim of this joggle 8 is to keep the panels 1, 2 at the same level, at the joint zone, so as to avoid having a gap between the said panels once they are connected to one another.

However, as is shown in FIG. 2, due to manufacturing tolerances on the various elements of the panel assembly involved in the liaison, the joint between the two panels 1, 2 generates a gap d in most cases. A gap is defined as being a displacement of the contiguous panels 1, 2 which should normally be flush at the same level once connected to one another. As a result, the longitudinal slot 6 between the panels 1, 2 forms a step which can disrupt the airflow over the outer surface of the panel assembly 1, 2.

It is not currently possible to remove the accepted manufacturing tolerances on the various elements of the assembly, without incurring a very high rise in the manufacturing costs of such an assembly.

### SUMMARY

In the aspects of the embodiments disclosed herein, it is sought to reduce the impact of the gap between two adjacent panels of a panel assembly, due to manufacturing and assembly tolerances, on the aerodynamic drag.

For this, in the disclosed embodiments, it is proposed to spread the gap between the two adjacent panels of a panel assembly, over an important length in order to reduce its impact on the aerodynamic drag.

According to the aspects of the disclosed embodiments, the state of the art step tolerance is transformed into undulation tolerance by using panels which have a surface at the joint zone that present a joggle designed to minimise the gap between the two panels. More specifically, each panel includes two successive plateaus, separated from one another by a step. The lowest or lower plateaus of each of the panels are face to face, the said panels being linked to one another at the level of their lower plateaus. Therefore, the gap, instead of being concentrated at the level of the longitudinal slot between the two panels, is spread over the total surface of the two adjacent lower plateaus. The risk of having a gap is not removed, but when it does occur it is spread over a larger surface, so that it is even possible, in some cases, to increase the manufacturing and assembly tolerances of the elements involved in the liaison between the two panels. The possible gap between the two panels, once the two panels are connected to one another, is therefore contained in a hollow created between the steps of the two panels facing each other. The hollow obtained can be of variable height, from one end to another of the said hollow, and also from one assembly to another. The height of the hollow is defined as being the dimension extending perpendicularly to the surface of the panels.

In a particular aspect of the disclosed embodiments, it is possible to create steps where the sum of the heights of the two facing steps is substantially equal to the sum of the accepted gap tolerances for manufacturing and assembly at the joint zone of two panels. The height of the step is defined as being the dimension extending perpendicularly to the surface of the panel. The term gap tolerance is defined as being the accepted gap tolerances for each of the parts involved in the connection of the two panels in the panel assembly. Therefore, once the panels are put together, a possible gap between the two panels is guaranteed to be within the hollow created by the lower plateaus of each of the two panels.

In order to completely remove the impact of an existing gap between the two panels, it is possible to pour a material, such as a mastic, into the hollow containing the gap. The gap is therefore submerged in the hollow and covered in mastic. The mastic forms a smooth surface providing a perfectly continuous surface, in other words, no difference in level, in the extension of the two panels in the panel assembly.

The object of the disclosed embodiments is therefore a panel assembly in which two panels are connected to one another, characterised in that one surface of each of the panels comprises a joggle, so as to include an upper plateau and a lower plateau, the two panels being connected to each other at their lower plateaus.

According to the aspects of the method according to the disclosed embodiments, all or some of the following additional characteristics are possible:
the sum of the heights of the joggles of the two panels is equal to the sum of the accepted gap tolerances in the joint zone between the two panels.
each joggle height is equal to half the sum of the accepted gap tolerances in the joint zone between the two panels.
the two panels are connected to one another via a liaison element.
a longitudinal slot, created between the two panels, is filled by a filling joint.
a hollow in the joint zone is filled by a smoothing joint.

Another aspect of the disclosed embodiments is aimed at a method of mounting such a panel assembly in which two panels are connected to one another, characterised in that it comprises the following steps:
adding together the accepted gap tolerances for the assembly elements involved in the connection of the two panels;
creating the two panels so that they both present a surface including a lower plateau and an upper plateau, the difference in height of their surfaces being such that the sum of the joggles of the two panels is noticeably equal to the sum of the tolerance gaps of the assembly elements involved in the connection of the two panels;
connecting the two panels by placing the two lower plateaus edge to edge to form the joint zone.

According to the examples of implementation of the method according to the disclosed embodiments, all or some of the following additional steps are possible:
filling a hollow in the joint zone with a smoothing joint.
creating the panels by moulding in moulds fitted with a moulding board corresponding to the expected joggle.
creating the panel through the machining of sheets in order to create the expected joggles.

### BRIEF DESCRIPTION OF THE DRAWINGS

The aspects of the disclosed embodiments will be more easily understood when reading the following description and studying the accompanying drawings. These are presented as an indication and are not limitative. The figures represent:

FIG. 1: a cross section view of an already described panel assembly, such as it should be in theory;

FIG. 2: a cross section view of a detail of a joint between two panels, at the level of a longitudinal slot stretching between the two panels, according to the state of the art previously described;

FIG. 3: a cross section view of two adjacent panels connected to one another according to the aspects of the disclosed embodiments;

FIG. 4: a cross section diagram of two adjacent panels according to the aspects of the disclosed embodiments;

FIG. 5: a cross section diagram of an aircraft wing able to be fitted with a panel assembly according to the aspects of the disclosed embodiments.

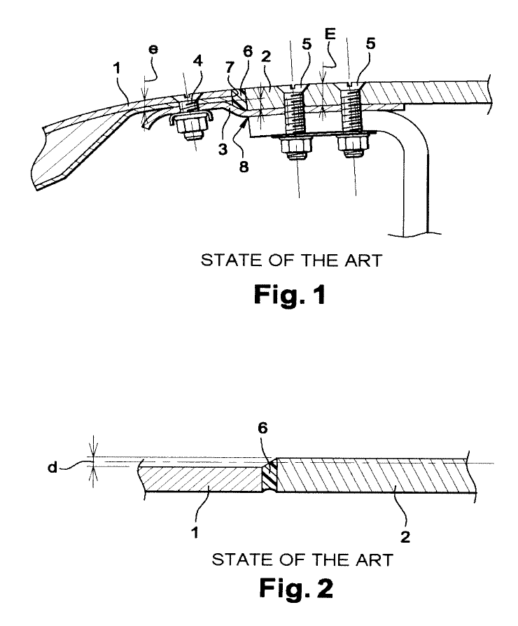

### DETAILED DESCRIPTION OF THE DISCLOSED EMBODIMENTS

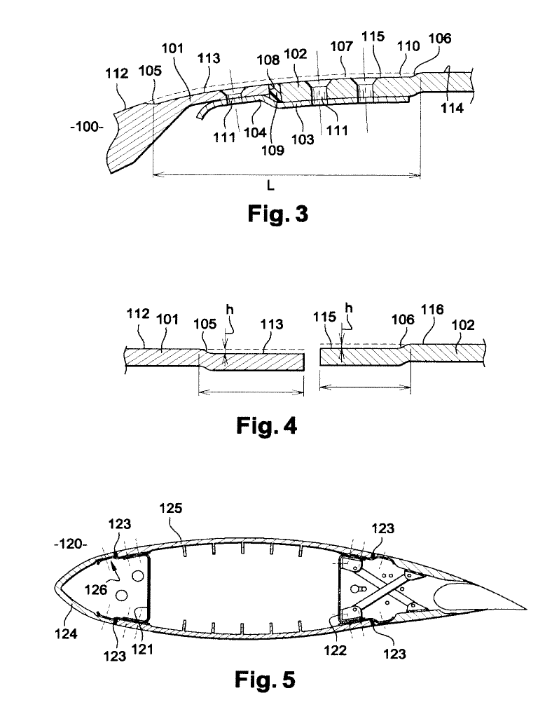

FIG. 3 represents a cross section of a panel assembly 100, in which two panels 101, 102 are connected to one another via a liaison 103 part.

The liaison 103 part comprises a joggle 104, designed to compensate for the difference in thickness between the first panel 101 and the second panel 102. Because the first panel 101 has a thickness strictly less than the thickness of the second panel 102, the joggle is positioned so that the additional thickness of panel 102 is included in the hollow of the joggle 104 of the liaison 103 part. Therefore, in theory the surfaces of the two panels 101, 102 are lined up with one another once the said panels 101, 102 are fixed to the liaison 103 part.

However, as has already been described above, because of the manufacturing tolerances on the liaison 103 part as well as on each of the panels 101,102, once the mounting is carried out, the hollow surfaces of the two panels 101, 102 are not lined up, and there is a gap in the joint between the two panels 101, 102.

Also, according to the aspects of the disclosed embodiments, each of the panels 101, 102 has a two-storey surface, respectively forming an upper plateau 112, 114 and a lower plateau 113, 115. The height h of the joggle 105, 106 between the upper plateaus 112, 114 and lower 113, 115 plateaus can act as normally accepted manufacturing and assembly tolerances for panel assembly, and therefore vary according to application, materials used etc.

In the example shown in FIG. 4, the panel 101 on the left in the figure, in relation to panel 102 on the right, comprises a joggle 105 descending from left to right, whereas panel 102 comprises a joggle 106 descending from right to left. Thus, once the panels 101, 102 are assembled, the lower plateaus form a concave surface, or a hollow 107, bordered by the upper plateaus 112, 114.

In preference, the height h of each of the height joggles 105, 106 is noticeably equal to half the combined sum of the tolerance gaps tolerated by the elements of the assembly involved in the joint between the two panels 101, 102.

In the example shown in FIG. 3, the sum of the gap tolerances corresponds to the accepted gap tolerances of each of the two panels 101, 102 and the liaison 103 part. Therefore, the sum of the heights h of the two joggles 105 and 106 is equal to the sum of the accepted manufacturing gap tolerances for the combination of parts 101, 102 and 103.

Once the panels 101 and 102 are fixed on the liaison 103 part, the possible gap between the panels 101 and 102 is spread over the entire length L of the hollow 107. The length L of the hollow, is defined as being the dimension of the hollow extending between the two joggles 105, 106.

In one particular aspect of the disclosed embodiments, it is possible to fill the longitudinal slot 108, extending between the edges of the panels 101, 102 bordering the said longitudinal slot 108, with a filling joint 109, such as a putty sealing mastic.

In addition, it is possible, in order to smooth the profile of the panel assembly at the joint between the two adjacent panels 101, 102, to fill the hollow 107 with a smoothing joint 110, such as a liquid coating mastic. A perfectly continuous surface is thus obtained which entirely covers the possible gap between the two panels 101 and 102.

Moreover, in the case where the panels 101 and 102 are connected to the liaison 103 part via screw 111, the said screw 111 being included in the hollow 107, they are also covered by the smoothing joint 110. It is thus possible to increase the tolerances of countersinks for countersunk screws 111.

As can be seen on FIG. 4, the thickness of panel 101, 102 is the same from one part to another of the height difference 105, 106.

In the example shown in FIG. 3, only the first panel 101 has a variable thickness. More specifically, the thickness of the first panel 101 on the upper plateau 112 is strictly greater than the thickness of the first panel 101 on the lower plateau 113. The upper plateau 116 and the lower plateau 115 of the second panel 102 have a continuous and identical thickness.

FIG. 5 shows a cross section of an aircraft wing 120 able to incorporate a panel assembly according to the aspects of the disclosed embodiments.

Indeed, in the case of an aircraft wing, it is necessary to be able to access the systems and paths situated in front of the front longeron 121 and behind the rear longeron 122 of the said wing 120. For this, the panels 124, 125 of the wing 120 are connected to one another in such a way as to create four longitudinal slots 123, at the site of which it is possible to have a gap between the adjacent panels 124, 125.

It is therefore possible, in the case of panels 124, 125 bordering at least one of the longitudinal slots 123 to create a panel assembly according to the aspects of the disclosed embodiments.

In one particular embodied example of such a wing 120, to carry out a panel assembly, it is necessary to use:
a composite wing panel 125, moulded externally with bladder internally, of a thickness 10 mm+/−4%, corresponding to +/−0.4 mm;
a composite panel 124, forming the tip of the leading edge of the wing 120, having a monolithic part of a thickness 4 mm+/−4% corresponding to +/−0.16 mm.
a metal strip 126, joggled with a +/−2% precision corresponding to +/−0.2 mm, the said strip 126 acting as liaison part between the two panels 124, 125.

The total of combined gap tolerances on the joint between the two panels 124, 125 therefore corresponds to the sum of the gap tolerances on the two panels 124, 125 and the strip 126, that is to say +/−0.76 mm. An aerodynamic reduction of +0.76 mm is thus obtained in forward gear according to the relative wind, and of −0.76 mm in reverse gear if the fault is centred on the theoretical profile.

The manufacturing tolerance range which can be obtained at the end of the assembly is therefore of 1.52 mm.

A +/−0.76 mm default is unacceptable. The direct use of a composite panel is therefore impossible when carrying out panel assembly according to the state of the art. It is necessary to locally reshape by machine the 5 composite panel axes of the moulded composite panel to calibrate its thickness to +/−0.1 mm. The equipment is adapted to the shape of the wing panel with appropriate clamping and the machining must be three-dimensional, requiring the use of a 5 axe milling machine.

With the metal panel, the default is of +/−0.46 mm, which is only just acceptable for an aeroplane flying at “mach” 0.8.

In the case where the panel assembly 124, 125 conforms to the aspects of the disclosed embodiments, it has been established that in order for the joints to fall within the accepted aerodynamic tolerances, the sum of the heights h of the joggles, divided by the length L of the hollow formed by the lower plateaus, must be less than or equal to 0.01, that is to say hₜₒₜₐₗL≦0.01. hₜₒₜₐₗ is defined as the sum of the heights h of the joggles of the panels before being connected.

For a gap tolerance of 1.52 mm to be acceptable, panels 124, 125 are used, where the sum of the joggles h is equal to 1.5 mm. The length L of the hollow at the joint zone should therefore be equal to 152 mm. This spread value is perfectly compatible with the definition for the location of fixings of each of the panels, for example 60 mm for the leading edge panel 124, and 10 mm for the wing panel 125. Moreover, the slight hollows thus created house the screw countersinking, which can have their gap tolerances increased, whilst they remain covered by the smoothing joint.

This is also applicable to metal panels in order to improve the aerodynamic profile.

Such panels according to the aspects of the disclosed embodiments, presenting a joggle of desired height h, can be obtained through moulding, by placing the impressions, or moulding boards, in the corresponding moulds. It is also possible to machine panels from panels with greater thicknesses to obtain the desired panels, presenting the required joggles.

What is claimed is:

1. Panel assembly in which two panels are connected to one another, wherein one surface of each of the panels comprises a joggle, so as to include an upper plateau and a lower plateau, the two panels being connected to each other at their lower plateaus.

2. Panel assembly according to claim 1, wherein the sum of the heights (h) of the joggles of the two panels is equal to the sum of the accepted gap tolerances in the joint zone between the two panels.

3. Panel assembly according to claim 1, wherein each joggle height of the two panels is equal to the sum of the accepted gap tolerances in the joint zone between the two panels.

4. Panel assembly according to claim 1, wherein the two panels are connected to one another via a liaison element.

5. Panel assembly according to claim 1, wherein a longitudinal slot, created between the two panels, is filled by a filling joint.

6. Panel assembly according to claim 1, wherein a hollow in the joint zone is filled by a smoothing joint.

7. A method of mounting a panel assembly in which two panels are connected to one another comprising:
adding together the accepted gap tolerances for the assembly elements involved in the connection of the two panels;
creating the two panels so that they both present a surface including a lower plateau and an upper plateau, and that the joggle of their surface is such that the sum of the heights (h) of the joggles of the two panels is noticeably equal to the sum of the tolerance gaps of the assembly elements involved in the connection of the two panels;
connecting the two panels by placing the two lower plateaus edge to edge to form the joint zone.

8. A method of assembly according to claim 7, further comprising:
filling a hollow in the joint zone with a smoothing joint.

9. A method of assembly according to claim 7, further comprising:
creating the panels by moulding in moulds fitted with a moulding board corresponding to the expected height difference.

10. A method of assembly according to claim 7, further comprising:
creating the panels by machining sheets in order to create the expected joggles.
